(19) United States
(12) Patent Application Publication
(10) Pub. No.: US 2015/0278776 A1
(43) Pub. Date: Oct. 1, 2015

(54) HYBRID, ELECTRONICALLY-LABELED, PAYMENT TRANSMISSION SOLUTIONS

(71) Applicant: Bank of America Corporation, Charlotte, NC (US)

(72) Inventors: Greg K. Murray, Morristown, NJ (US); Gregory P. Burns, New York, NY (US); James A. Kenny, Little Falls, NJ (US)

(21) Appl. No.: 14/627,087

(22) Filed: Feb. 20, 2015

Related U.S. Application Data
(60) Provisional application No. 61/970,948, filed on Mar. 27, 2014.

(51) Int. Cl. G06Q 20/10; G06Q 20/24; G06Q 20/02

(52) U.S. Cl. CPC G06Q 20/10; G06Q 20/023; G06Q 20/24

(57) ABSTRACT

An apparatus may perform a method for facilitating cross border transactions from an originator to a beneficiary. The originator may be associated with an originator financial institution (“FI”) and the beneficiary may be associated with a beneficiary FI. The method may include receiving wired funds in a first currency and initiating an ACH credit in either the first currency or a second currency. The ACH credit may correspond to the amount of the wired funds. The method may also include compressing information associated with the wired funds to form a necessary pre-cursor to initiating the ACH. The compressing may identify fields in the information associated with the wiring. The compressing may also select fields from the identified fields independent of fields required for initiating the ACH. The compressing may further include deleting information located in the selected fields. The method may also include transmitting a communication to the beneficiary that relates to the receipt time of the wire. The communication may be an e-mail to the beneficiary electronically labeled as having been generated by the originator FI.

### CROSS REFERENCE TO RELATED APPLICATION

This application is a non-provisional application of U.S. Provisional Application No. 61/970,948 entitled “Hybrid Payment Solution”, filed on Mar. 27, 2014.

### FIELD OF TECHNOLOGY

The disclosure relates to techniques for facilitating cross-border payments.

### BACKGROUND OF THE DISCLOSURE

A correspondent bank is generally understood to be a financial institution that provides services on behalf of another, equal or unequal, financial institution. A correspondent bank can conduct business transactions, accept deposits, make payments and/or gather documents on behalf of the other financial institution.

Correspondent banks are used by domestic banks in order to service transactions originating in foreign countries, and act as a domestic bank's agent abroad. This is done because the domestic bank may have limited access to foreign financial markets, and cannot service its client accounts without opening up a branch in another country. In addition, the domestic bank may also not possess the necessary regulatory licenses required to practice in the other country.

In one exemplary situation, a customer of a United States Bank may wish to pay a German firm EUR 1,000,000 for machinery. The US Bank determines that this is equivalent to USD 1,400,000. The US Bank takes the USD 1,400,000 out of the customer's bank account, and instructs its German correspondent bank to take EUR 1,000,000 out of the US Bank's correspondent account with the German correspondent bank, and pay the money to the German company in EUR.

In the end, the customer has its machinery; the supplier has its money (in EUR) and the US Bank is more or less at equilibrium by having fewer EUR in a correspondent account at a foreign bank, and a correspondingly greater amount of USD in its domestic account.

Correspondency between financial institutions may be established through bilateral agreements between two counterparts to support the multi-lateral economic balances established throughout the globe.

It would be desirable to increase efficiency of cross-border transactions in order to enhance the operation of financial institutions in their role as correspondent banks

### SUMMARY OF THE DISCLOSURE

Systems and methods for facilitating cross border transactions from an originator firm to a beneficiary firm, wherein the originator firm is associated with an originator financial institution (“FI”) and the beneficiary firm is associated with a beneficiary FI, are provided. The method may preferably include receiving wired funds in a first currency from the originator FI, and initiating an ACH credit to the beneficiary FI, the ACH credit substantially corresponding to the amount of the wired funds.

In certain embodiments, methods including initiating a credit using methods and/or apparatus other than the methods and/or apparatus associated with an ACH are also contemplated by the invention and within the scope of this disclosure. The embodiments may also include selecting a delivery system for initiating credit to a beneficiary.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows another illustrative apparatus in accordance with the principles of the invention;

FIG. 3 shows illustrative steps of a process in accordance with the principles of the invention;

FIG. 4 shows illustrative steps of another process in accordance with the principles of the invention; and

FIG. 5 shows illustrative steps of yet another process in accordance with the principles of the invention.

### DETAILED DESCRIPTION OF THE DISCLOSURE

Originators of cross-border transfers of funds typically lack the knowledge of exactly when the beneficiary of such transfers will receive the funds. Moreover, the nature of the open-network system has caused correspondent banks to not be able to provide an end-to-end tracking model for such transfers. Accordingly, beneficiaries of such transfers i.e., recipients—typically have little advance notice about the receipt of a cross-border transfer such as a cross-border wire payment.

Furthermore, due to the global nature of USD clearing clients, the time zone differential between the locations of originators and beneficiaries in the US or elsewhere can further delay the communication with the originator.

In addition to all the above-stated issues, originators are becoming increasingly frustrated with the number and amount of deductions from principal on a cross-border wire payment. For example, if the wire payment originated from a Germany firm and was transferring funds to a firm in Indonesia via US correspondent banks, then, in a situation where a first US bank had a relationship with the German firm and a second US bank had a relationship with the Indonesian firm, then there may be a total of four financial institutions (“FI”) through which the transaction runs: a German FI associated with the originating firm, a first US FI via local US Clearing Networks such as CHIPS and/or Fedwire associated with the German FI, a second US FI associated with the first US FI, and an Indonesian FI associated with the second US FI and with the recipient firm. In such a circumstance, there may be fees charged by each of the four FIs that participate in the transaction. Accordingly, conventional cross-border transactions may include a large number of deductions from principal prior to delivery of the funds.

In particular, credit side deductions—i.e., deductions associated with crediting the recipient firm via the second correspondent FI and the FI local to the recipient—have become a challenge for USD clearing.

Some embodiments may preferably provide a hybrid payment solution wherein the debit side is implemented via a wire transfer and the credit side is completed via a local i.e., in the country of receipt—automated clearing house (“ACH”).

ACH is an electronic network for financial transactions. ACH processes large volumes of credit and debit transactions in batches. ACH credit transfers may be used for direct deposit payroll and vendor payments. ACH transfers may include consumer payments on insurance premiums, mortgage loans, and other kinds of bills. Businesses increasingly use ACH online to have customers pay, rather than via credit or debit cards. ACH systems are also present in countries other than the US, where they may be alternatively referred to as low-value clearing systems.

The Federal Reserve Banks are collectively the nation's largest automated clearing house operator, and in 2005 processed 60% of commercial interbank ACH transactions. The Electronic Payments Network (“EPN”), the only private-sector ACH operator in the U.S., processed the remaining 40%. FedACH is the Federal Reserve's centralized application software used to process ACH transactions. Reserve Banks and the EPN rely on each other for the processing of some transactions when either party to the transaction is not their customer. These interoperator transactions are settled by the Reserve Banks

The foregoing typically only refers to US ACHs. US ACHs typically only serve US to US transactions. For cross-border payments, a wire/correspondent bank combination is typically used because cross-border ACH is not as mature for end-to-end ACH. Systems and methods according to the invention may fuse the cross-border origination capabilities of wire transfers with the efficiency of foreign-based—i.e., foreign originator to foreign beneficiary—or foreign-targeted—i.e., domestic originator to foreign beneficiary—ACHs. It should be noted that foreign-based and/or foreign-targeted ACHs may, and typically do, operate under different rules from the rules set forth above regarding US ACHs. It should be noted that the methods and apparatus associated with US ACH transactions and/or foreign ACH transactions are within the scope of the present embodiments.

The ACH payment system, according to the invention, may be used by FIs for business-to-business payments, payment of consumer bills such as mortgages, loans, utilities, insurance premiums, rents, and any other regular payment.

To return to the embodiments, delivering via local ACH preferably limits the fees (ACH's tend to be free or incur a relatively small fee because they are automated, whereas wire transfers incur a relatively large fee because of the immediacy, irrevocability and various compliance burdens associated with cross-border transfers) taken by additional correspondent FIs and adds the desired transparency to the transfer. Furthermore, with the advent of time-guaranteed ACH transfers in many foreign jurisdictions, such a system preferably limits the time for funds delivery to a known value.

A hybrid system may combine wire transfer with ACH. The hybrid system may perform as follows. The hybrid system may execute a method for facilitating cross border transactions from an originator firm to a beneficiary firm. The originator firm may be associated with an originator financial institution (“FI”). The beneficiary firm may be associated with a beneficiary FI. The originator FI may be domestic or foreign. The beneficiary FI may be domestic or foreign.

The system may receive wired funds in a first currency from the originator FI. The system may, in response to receiving wired funds, initiate an ACH credit in one of the first currency and a second currency to the beneficiary FI. The ACH credit may substantially correspond to the amount of the wired funds.

The initiating the ACH credit to the beneficiary FI may further include contacting an FI local to the beneficiary that is not the beneficiary FI.

Certain embodiments may also include compressing information associated with a wiring of the wired funds. The compressing may form a necessary pre-cursor to the initiating the ACH. In certain embodiments, the compressing may not be required to initiate the ACH. In jurisdictions where compressing data is unlawful, then the method should preferably be implemented independent of data compression.

The compressing may further include identifying fields in the information associated with the wiring of the wired funds. The compressing may include selecting fields from among the identified fields in the information associated with the wiring of the wired funds that are not critical to the initiating the ACH, and deleting the information located in the selected fields.

The embodiments may further include transmitting, by electronic transmission, a communication to the beneficiary. The communication may include information relating to the receipt time of the wiring of the wired funds. The communication may include information relating to the time of initiating the ACH. The communication may include information specifying a time window for arrival of the ACH. The communication comprises specifying latest time of arrival of the ACH. The communication may indicate that the communication is generated by the originator firm and/or the originating FI, although it is generated by neither.

In addition, such a hybrid system may protect the revenue stream of the single correspondent FI associated with the originator FI and also allow the single correspondent FI to control the foreign exchange (“FX”) rates in a way that provides both transparency and stability to the transaction, and also improves the foreign exchange rate for the beneficiary. In conventional exchanges, the last bank in the chain—e.g., the recipient FI—typically provides foreign exchange services and performs the conversion to the recipient's currency at a conversion rate determined by the recipient FI.

Furthermore, embodiments may allow the originator and beneficiary to negotiate better trade terms.

Beneficiaries, in some embodiments, may be notified exactly when a payment has been processed from an originator FI to the beneficiary FI's account. This typically happens in a relatively short period of time; on the order of a few minutes.

Beneficiaries, in some embodiments, can also proceed directly to their beneficiary FI with questions about the payment. In conventional cross-border transfers, the beneficiary was required to go back to the originator, which required the originator to then flow the query through every FI in the chain—thereby slowing query resolution time.

Some embodiments may involve one or more e-mail transmission(s) from an e-mail transmission device and/or exchange(s) between the first, and preferably only, correspondent FI and the recipient. The e-mail exchange may transmit transaction status information from the originator, the originator's FI, and/or the first correspondent FI. The e-mail transmission itself, however, may preferably be generated by the first correspondent FI.

In certain embodiments, the e-mail transmission may be generated by an e-mail account that is associated with, and/or controlled by, the single correspondent FI, but is “white”-labeled as originating at the originator and/or the originator's FI. For example, the correspondent FI (which may be a U.S.-based bank) may generate an e-mail to the recipient that states, in pertinent part, “XXX$ is scheduled for delivery by ACH transmission to XX Bank in Germany, from originator Mr. Lee of Singapore, on behalf of the account of recipient, Mr. Schmidt.” Such an e-mail may be sent from an address of donotreply@SingaporeBANK.com, which may not be indicative of the e-mail source—i.e., the correspondent FI. Furthermore, such an e-mail may preferably, by agreement between the correspondent FI and the originator and/or the originator's FI, copy (or blind copy (BCC)) the originator Mr. Lee and/or the originator's FI, so that Mr. Lee and/or his associated FI is aware of any e-mails sent on his behalf from the correspondent FI.

In conventional systems, beneficiaries have little advance notice about the receipt of cross-border wire payments. The communication channel described herein, and electronic transmissions, associated therewith, may efficiently inform the beneficiary regarding the funds transfer and may, under certain circumstances, enable a communication line between the originator and beneficiary. The channel set forth above solves the technical communication problem of the beneficiary not knowing the timing of when the funds are scheduled to arrive. Following receipt of the transmission information, the beneficiary is able to inquire directly with its FI regarding the payment status. Furthermore, such a channel as set forth herein, and such transmissions, may mitigate the time zone differential between the originator and the beneficiary by generating the communication from a more centrally located-intermediary.

Through identification of a beneficiary contact point (email address, mobile phone number, etc), a direct notification to the beneficiary can occur once the transaction has been processed. This technical solution informs the beneficiary that funds are at or on their way to the beneficiary and allows him or her to inquire directly with his or her FI regarding payment status.

In some embodiments, the email transmission from, for example, the correspondent FI to the beneficiary, may indicate one or more of the following: 1) that a wire was generated on______, and 2) received on ______; 3) in response to the wire, an ACH was generated at ______ 4) and the ACH generated at ______ was scheduled for delivery at the beneficiary FI no later than ______.

While the embodiments preferably enhance transparency of the transaction, nevertheless the embodiments may rely, to some extent, on information provided by the originator and/or the originator's FI. In such instances, the system may rely, at least in part on the originator's maintenance of security over e-mail and mobile networks.

In some embodiments, certain financial risks faced by the correspondent bank may be mitigated through fixed financial remuneration e.g.—$50 or $100 payments—in the instance of failed, or late performance. Some embodiments may also include agreements to exclude certain beneficiary banks from being covered under the delivery commitment.

Certain embodiments may also enhance the ability of cross-border transfers to appropriately meet time-zone challenges between certain markets and various country's disparate business hours. In some instances, embodiments may also be able to provide intra-day resolution of a transaction and/or query.

Some methods for facilitating cross border transactions may include facilitating cross-border transactions between an entity and a beneficiary firm. Such a cross border transaction may be initiated by a sub-entity that is a portion of the entity, but is located remotely—i.e., across an international border—therefrom. The beneficiary firm may be associated with a beneficiary FI.

The methods may include receiving wired funds—or other instructions to transfer, or actual transfer of funds—from the foreign sub-entity and initiating a credit to the beneficiary FI. The credit may substantially correspond to the amount of, or at least a portion of, the wired funds. It should be noted that, while the credit may substantially correspond to the amount of, or at least a portion of, the wired funds, the currency of the ACH credit may differ from the currency of the wired funds for those payments that involve a Foreign Exchange transaction.

The initiating of the credit to the beneficiary FI may also include contacting an FI local to the beneficiary that is not the beneficiary FI. It should be noted that the credit may be initiated and/or completed using ACH or any other suitable delivery mechanism or mechanisms.

Illustrative embodiments of apparatus and methods in accordance with the principles of the invention will now be described with reference to the accompanying drawings, which form a part hereof It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

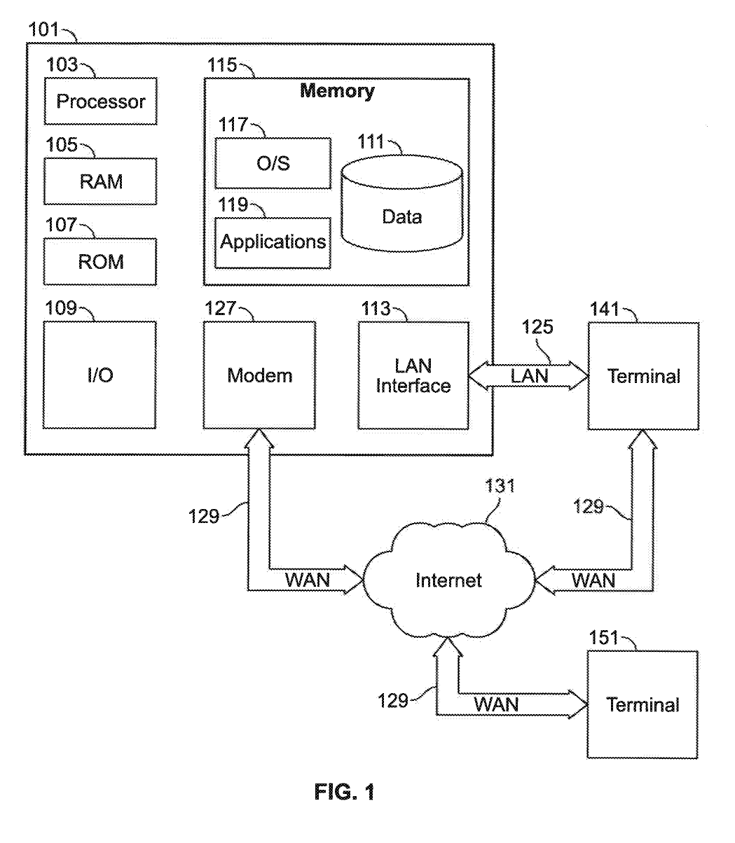

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for transfer information input into one or more of the database(s) described herein, as well as beneficiary information, originator information, wire information, ACH information, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

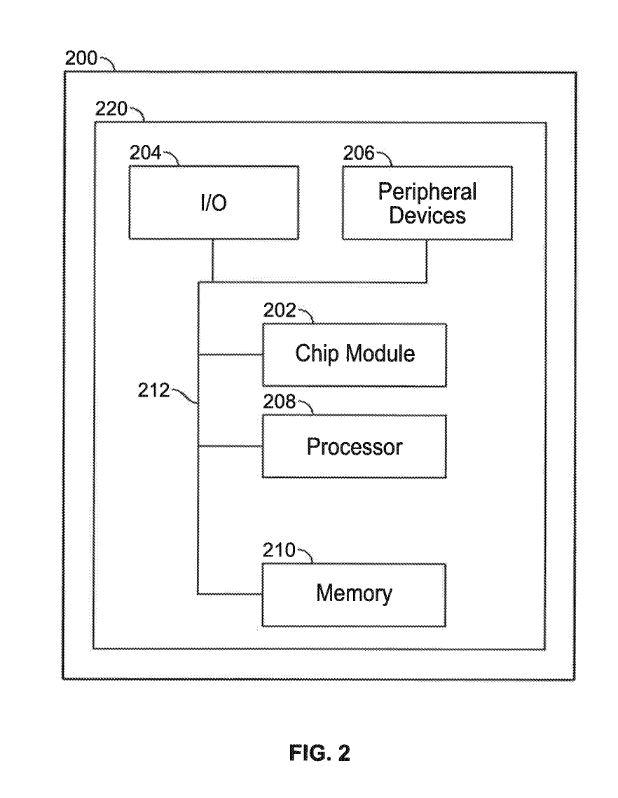

FIG. 2 shows an illustrative apparatus that may be configured in accordance with the principles of the invention.

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data, quantify indicies; and machine-readable memory 210.

Machine-readable memory 210 may be configured to store in machine-readable data structures: data lineage information; data lineage, technical data elements; data elements; business elements; identifiers; associations; relationships; and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

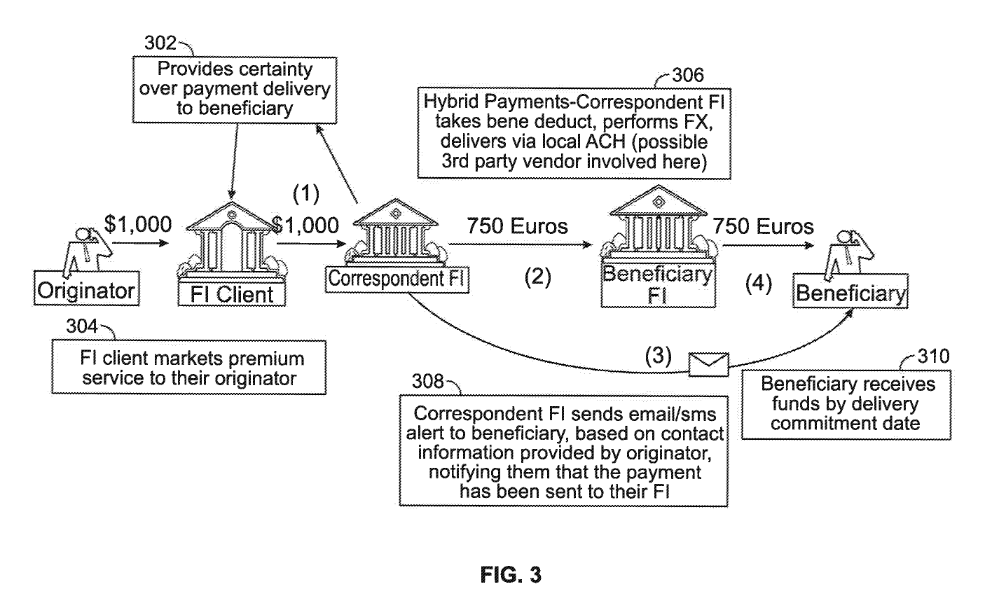

FIG. 3 shows, at step 302, providing certainty over payment delivery to a beneficiary. At step 304, FIG. 3 shows that an FI client can market such a service as shown in the embodiments as a premium service to its originator.

Step 306 shows that for hybrid payments, a correspondent FI may take a deduction from the funds transferred to the beneficiary (“a bene deduct”), perform the necessary FX to complete the transaction, and deliver the funds to the beneficiary FI (or other suitable destination such as the beneficiary itself when possible and/or practical) via a local ACH. Such a local ACH may use a 3^{rd} party vendor local to the beneficiary where necessary, and/or applicable.

Step 308 shows that the correspondent FI may send an e-mail transmission, an SMS transmission or other suitable transmission, to the beneficiary, preferably based on contact information provided by the originator, to notify the beneficiary that the payment has been sent to the beneficiary FI. It should be noted that embodiments may preferably implement various methods to attribute the transmission of the e-mail to selected parties, as needed to insure security of the transmission and/or transparency of the transaction.

Step 310 shows that the beneficiary may preferably receive the funds by the delivery commitment date.

In certain circumstances, the first leg of the hybrid payment solution—i.e., the wire transmission—may include more characters than a typical ACH solution. For example, a typical outgoing, cross-border, wire transmission may include, for example, up to about 174 characters for use in identifying the account being credited. The 174 characters may include the beneficiary's bank account number (and/or bank identifying information), the beneficiary's name and address, the ABA number of the receiving bank, and/or the receiving bank identification number and information, remarks and an amount of the wire transfer. A conventional cross-border FI may also require identification information for one or more intermediary FIs. It should be understood that the 174 characters is an exemplary number and wire transmissions may include more or less than 174 characters for identifying the account being credited.

An ACH, on the other hand, may be configured to include less characters than a wire transfer transmission. For example, a typical ACH transmission may only provide room for up to about 94 characters—although it should be understood that the ACH transmission may be any suitable number of characters. Such characters may provide for a file header record (which may include the originators company name), a batch header record (which may include the entry date of the ACH), an entry detail record (which may information such as the recipient's name, account number and dollar amount of the payment), batch control total and file control record, among others. Accordingly, systems and methods according to the invention are faced with the technical problem of compressing the wire transmission into an ACH transmission while preserving sufficient information to successfully complete the ACH transmission. The payment solution may require more or less compression, as a function of the national jurisdictions associated with the originator, the recipient and/or the correspondent FI. More specifically, the payment solution may require more or less compression as a function of the wire/ACH standards associated with the various national jurisdictions. It should be understood that the 94 characters is an exemplary number and/or ACH may include more or less than 94 characters for identifying the account being credited.

In certain embodiments, the hybrid payment solution may extract only the necessary beneficiary's identification information, as well as the beneficiary's bank information from the wire transmission such that the extracted information may then be placed in the appropriate portion of the ACH in such a way that can allow the ACH to be completed successfully.

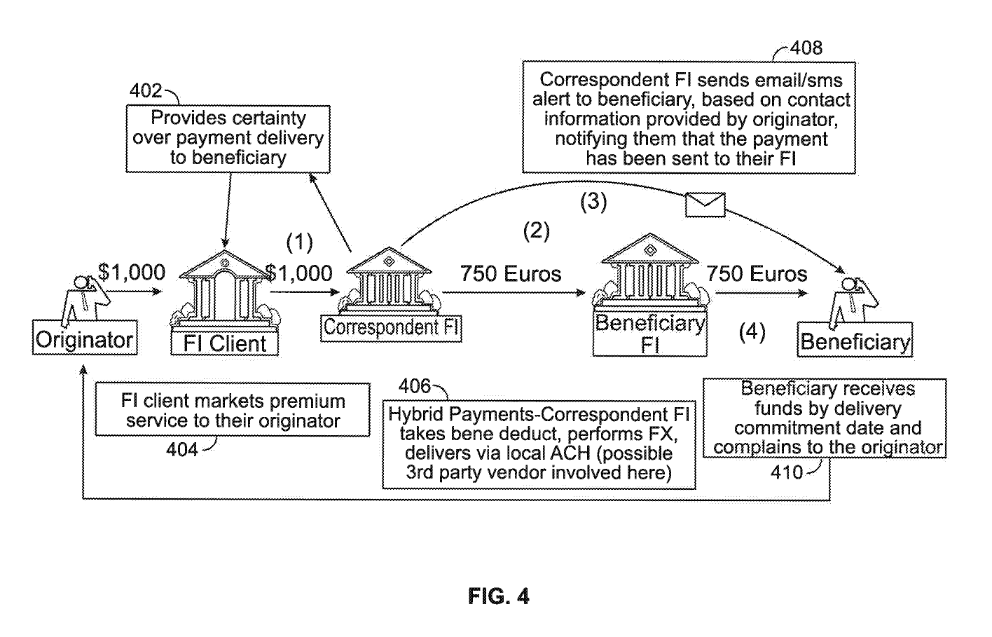

FIG. 4 shows, at steps 402-408, similar method steps as shown in FIG. 3. However, at step 410, the beneficiary may receive the funds and may complain to the originator regarding a late delivery of funds and/or a higher than expected bene deduct.

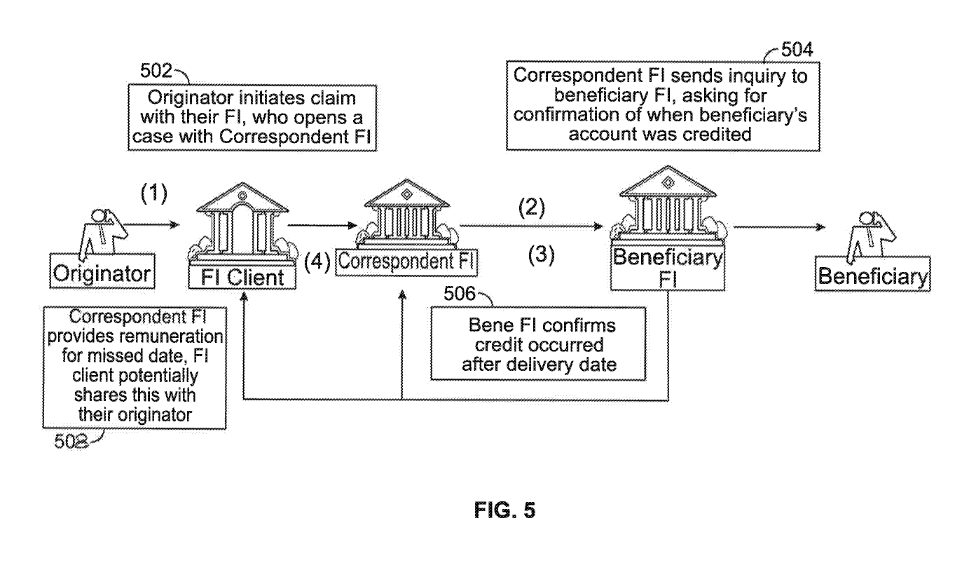

FIG. 5 is a continuation of the method shown in FIG. 4. FIG. 5 shows, at step 502 that the originator, following receipt of an e-mail from the beneficiary, may initiate a claim with its FI who, in turn, opens a case with the correspondent FI. Preferably thereafter, at step 504, the correspondent FI may send an inquiry to the beneficiary FI, requesting confirmation of when beneficiary's account was credited.

At step 506, the beneficiary FI may confirm that credit occurred after delivery date. At step 508, the correspondent FI may provide remuneration for missed date; and the originator FI as well as the originator, may also share in this liability.

Thus, methods and apparatus for a hybrid payment solution have been provided. Persons skilled in the art will appreciate that the present invention can be practiced in embodiments other than the described embodiments, which are presented for purposes of illustration rather than of limitation, and that the present invention is limited only by the claims that follow.

1. An article of manufacture comprising a non-transitory computer usable medium having computer readable program code embodied therein, the code when executed by one or more processors configuring a computer to execute a method for facilitating cross border transactions from an originator firm to a beneficiary firm, wherein the originator firm is associated with an originator financial institution (“FI”) and the beneficiary firm is associated with a beneficiary FI, the method comprising:
receiving wired funds in a first currency from the originator FI;
initiating an ACH credit in one of the first currency and a second currency to the beneficiary FI, wherein the ACH credit substantially corresponds to the amount of the wired funds; and
transmitting, by electronic transmission, a communication to the beneficiary firm;
wherein the communication indicates that the communication is generated by the originator firm and/or the originating FI, although it is generated by neither.

2. The article of manufacture of claim 1, wherein the initiating the ACH credit to the beneficiary FI further comprises contacting an FI local to the beneficiary that is not the beneficiary FI.

3. The article of manufacture of claim 1, wherein the method further comprises compressing information associated with a wiring of the wired funds, said compressing forming a necessary pre-cursor to the initiating the ACH.

4. The article of manufacture of claim 3, wherein the compressing further comprises identifying fields in the information associated with a wiring of the wired funds, selecting fields from among the identified fields in the information associated with a wiring of the wired funds that are not critical to the initiating the ACH, and deleting the information located in the selected fields.

5. The article of manufacture of claim 1, wherein the communication comprises information relating to the receipt time of the wiring of the wired funds.

6. The article of manufacture of claim 1, wherein the communication comprises information relating to the time of initiating the ACH.

7. The article of manufacture of claim 1, wherein the communication comprises information specifying a time window for arrival of the ACH.

8. The article of manufacture of claim 1, wherein the communication comprises specifying latest time for arrival of the ACH.

9. An article of manufacture comprising a non-transitory computer usable medium having computer readable program code embodied therein, the code when executed by one or more processors configuring a computer to execute a method for facilitating cross-border transactions between an entity and a beneficiary firm, the cross border transaction initiated by a sub-entity within the entity, wherein the sub-entity is located across an international border from the portion of the entity that is facilitating the cross-border transaction, wherein the beneficiary firm is associated with a beneficiary FI, the method comprising:
receiving wired funds from the first sub-entity; and
initiating an ACH credit to the beneficiary FI, wherein the ACH credit substantially corresponds to the amount of the wired funds; and
transmitting, by electronic transmission, a communication to the beneficiary firm;
wherein the communication indicates that the communication is generated by the originator firm and/or the originating FI, although it is generated by neither.

10. The article of manufacture of claim 9, wherein the initiating the ACH credit to the beneficiary FI further comprises contacting an FI local to the beneficiary that is not the beneficiary FI.

11. An article of manufacture comprising a non-transitory computer usable medium having computer readable program code embodied therein, the code when executed by one or more processors configuring a computer to execute a method for facilitating cross border transactions from an originator firm to a beneficiary firm, wherein the originator firm is associated with an originator financial institution (“FI”), the method comprising:
receiving wired funds from the originator FI;
selecting a delivery mechanism from a group consisting of ACH and wire transfer to deliver the funds to the beneficiary firm; and
initiating the delivery of the funds, using the selected delivery mechanism to the beneficiary firm, wherein the amount of funds for delivery substantially corresponds to the amount of the wired funds.

12. The article of manufacture of claim 11, wherein the initiating the ACH credit to the beneficiary firm further comprises contacting an FI local to the beneficiary that is associated with the originator firm.

13. An article of manufacture comprising a non-transitory computer usable medium having computer readable program code embodied therein, the code when executed by one or more processors configuring a computer to execute a method for facilitating cross border transactions from an originator firm to a beneficiary firm, wherein the originator firm is associated with an originator financial institution (“FI”) and the beneficiary firm is associated with a beneficiary FI, the method comprising:
receiving wired funds in a first currency from the originator FI; and
initiating an ACH credit in one of the first currency and a second currency to the beneficiary FI, wherein the ACH credit substantially corresponds to the amount of the wired funds;
compressing information associated with a wiring of the wired funds, said compressing forming a necessary pre-cursor to the initiating the ACH, the compressing further comprising:
identifying fields in the information associated with a wiring of the wired funds;
selecting fields from among the identified fields in the information associated with a wiring of the wired funds that are independent of fields required for initiating the ACH; and
deleting the information located in the selected fields;
transmitting, by electronic transmission, a communication to the beneficiary;
wherein the communication comprises information relating to the receipt time of the wiring of the wired funds;
wherein the communication further comprises an e-mail to the beneficiary, said e-mail being electronically labeled as having been generated by, or associated with, the originator FI.

14. The article of manufacture of claim 12, wherein the communication comprises information relating to the time of initiating the ACH.

15. The article of manufacture of claim 13, wherein the communication comprises information relating to the time of initiating the ACH.

16. The article of manufacture of claim 13, wherein the communication comprises information specifying a time window for arrival of the ACH.

17. The article of manufacture of claim 13, wherein the communication comprises specifying latest time for arrival of the ACH.
